(19) United States
(12) Patent Application Publication
(10) Pub. No.: US 2023/0180832 A1
(43) Pub. Date: Jun. 15, 2023

(54) AEROSOL GENERATION DEVICE WITH IMPROVED HEATING EFFICIENCY

(71) Applicant: KT&G CORPORATION, Daejeon (KR)

(72) Inventors: Chul Ho JANG, Daejeon (KR); Gyoung Min GO, Daejeon (KR); Hyung Jin BAE, Daejeon (KR); Jang Won SEO, Daejeon (KR); Min Seok JEONG, Daejeon (KR); Jong Seong JEONG, Daejeon (KR); Jin Chul JUNG, Daejeon (KR)

(73) Assignee: KT&G CORPORATION, Daejeon (KR)

(21) Appl. No.: 17/786,150

(22) PCT Filed: Jul. 16, 2021
(86) PCT No.: PCT/KR2021/009177

§ 371 Date: Jun. 16, 2022

(30) Foreign Application Priority Data
Sep. 1, 2020 (KR) 10-2020-0111062

(51) Int. Cl. A24F 40/46; A24F 40/20; A24D 1/20; H05B 3/20; H05B 6/10

(52) U.S. Cl. CPC A24F 40/46; A24D 1/20; A24F 40/20; H05B 3/20; H05B 6/10

(57) ABSTRACT

An aerosol generation device with improved heating efficiency is provided. The aerosol generation device according to some embodiments of the present disclosure includes a case in which an insertion hole is formed to receive an aerosol-generating article, a heater configured to heat the aerosol-generating article inserted through the insertion hole to generate an aerosol, and an adapter disposed between the insertion hole and the heater. The adapter may allow a medium portion of the inserted aerosol-generating article to be deformed to a desired pressed shape so that the heating efficiency of the heater is improved.

### [TECHNICAL FIELD]

The present disclosure relates to an aerosol generation device with improved heating efficiency, and more particularly, to an aerosol generation device capable of improving the heating efficiency of a heater to reduce a preheating time and enhance a tobacco smoke taste of an aerosol-generating article.

### [BACKGROUND ART]

In recent years, demand for alternative smoking articles that overcome disadvantages of traditional cigarettes has increased. For example, demand for aerosol generation devices (e.g., cigarette-type electronic cigarettes) that electrically heat cigarettes to generate an aerosol has increased, and accordingly, active research has been carried out on electric heating-type aerosol generation devices.

General electric heating-type aerosol generation devices employ a structure in which a heater disposed around a cigarette heats a medium of the cigarette from the outside. However, in such a structure, since a considerable amount of time is taken to evenly heat the outer portion of the medium and a central portion thereof. As a result, the heating efficiency of the heater is decreased, and a preheating time is inevitably increased.

For example, FIG. 1 illustrates temperature changes for each portion of the medium of the cigarette in the above-described heating structure. As illustrated, the central portion of the medium that is relatively far from the heater is heated more slowly than the outermost portion of the medium. Accordingly, a considerable amount of time (e.g., T1) is taken to evenly heat the entire medium, which indicates that the preheating time of the device is increased and the heating efficiency of the heater is decreased.

As a result, in the electric heating-type aerosol generation device that employs the above-described heating structure, the preheating time is inevitably increased due to the poor heating efficiency of the heater, and a tobacco smoke taste at the beginning of smoking may be poor in a case in which a sufficient preheating time is not secured.

### [DISCLOSURE]

### [Technical Problem]

Some embodiments of the present disclosure are directed to providing an aerosol generation device capable of improving the heating efficiency of a heater to reduce a preheating time and enhance a tobacco smoke taste of an aerosol-generating article.

Some embodiments of the present disclosure are also directed to providing an aerosol generation device that has a function allowing easy removal of an aerosol-generating article.

Objectives of the present disclosure are not limited to the above-mentioned objectives, and other unmentioned objectives should be clearly understood by those of ordinary skill in the art to which the present disclosure pertains from the description below.

### [Technical Solution]

An aerosol generation device according to some embodiments of the present disclosure includes a case including an insertion hole for receiving an aerosol-generating article, a heater configured to generate an aerosol by heating the aerosol-generating article inserted in the insertion hole, and an adapter disposed between the insertion hole and the heater configured to deform a medium portion of the inserted aerosol-generating article to a desired pressed shape.

In some embodiments, a cross-section of the insertion hole may have a shape in which a cross-section of the aerosol-generating article and a cross-section of the desired pressed shape are combined.

In some embodiments, the adapter may include a first open end portion disposed on the insertion hole side and a second open end portion disposed on the heater side, and while the inserted aerosol-generating article is moved toward the second open end portion through the first open end portion, the medium portion may be deformed to the desired pressed shape due to an inner shape of the adapter.

In some embodiments, a cross-section of the first open end portion may have a shape in which the cross-section of the aerosol-generating article and the cross-section of the desired pressed shape are combined.

In some embodiments, a cross-section of the second open end portion may match the cross-section of the desired pressed shape.

In some embodiments, a cross-sectional area of an inner space of the adapter may tend to decrease from the first open end portion toward the second open end portion.

In some embodiments, at least a portion of the inner space of the adapter may have an inclined structure, and an angle of inclination of the at least one portion with respect to a longitudinal axis of the aerosol-generating article may be in a range of 10° to 40°.

In some embodiments, at least a portion of the inner space of the adapter may have an inclined structure, and an angle of inclination of the at least one portion with respect to the longitudinal axis of the aerosol-generating article may tend to increase from the first open end portion toward the second open end portion.

In some embodiments, treatment to reduce a surface roughness may be performed on at least a portion of an inner surface of the adapter.

In some embodiments, a thickness of the medium portion deformed to the desired pressed shape may be in a range of 20% to 80% of a thickness of the medium portion before deformation.

### [Advantageous Effects]

According to some embodiments of the present disclosure, during insertion of an aerosol-generating article, a medium portion thereof can be naturally deformed to a desired pressed shape upon passing through an adapter. Accordingly, a distance from a heater to a central portion of the medium portion can be decreased, and the heating efficiency of the heater can be improved. For example, temperature differences between portions of the medium portion can be minimized, and an aerosol-forming substrate can rapidly reach a target temperature. Also, due to the improvement in heating efficiency, a preheating time of an aerosol generation device can be reduced, power consumption can be reduced, and a tobacco smoke taste of the aerosol-generating article can be enhanced.

Also, since the heater has a shape that matches the desired pressed shape of the medium portion, the heating efficiency of the heater can be further improved.

In addition, since a cross-section of an insertion hole and a cross-section of an open end portion of an adapter each have a shape in which a cross-section of the aerosol-generating article and a cross-section of the desired pressed shape are combined, both insertion and removal of the aerosol-generating article can be easily performed. For example, since the aerosol-generating article deformed to the desired pressed shape can be removed without being caught in the insertion hole or adapter, a problem in which the medium portion or a wrapper is damaged during the removal can be prevented.

The advantageous effects according to the technical spirit of the present disclosure are not limited to the above-mentioned advantageous effects, and other unmentioned advantageous effects should be clearly understood by those of ordinary skill in the art from the description below.

### [DESCRIPTION OF DRAWINGS]

FIG. 1 is a view illustrating a problem in which heating efficiency decreases and a preheating time increases in an electric heating-type aerosol generation device having an external heating structure.

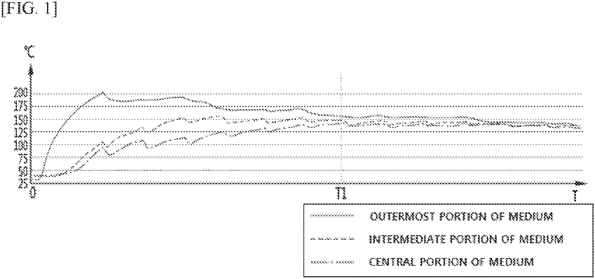

FIG. 2 is an exemplary view schematically illustrating an aerosol generation device according to some embodiments of the present disclosure.

FIG. 3 is an exemplary exploded view schematically illustrating the aerosol generation device according to some embodiments of the present disclosure.

FIG. 4 illustrates a state in which an aerosol-generating article is inserted into the aerosol generation device according to some embodiments of the present disclosure.

FIG. 5 is an exemplary view illustrating the shape of a cross-section of an insertion hole according to some embodiments of the present disclosure.

FIG. 6 is an exemplary view illustrating a detailed structure of an adapter according to some embodiments of the present disclosure.

FIG. 7 illustrates a process in which the shape of the aerosol-generating article is deformed through the adapter according to some embodiments of the present disclosure.

FIG. 8 illustrates the shape of the aerosol-generating article deformed through the adapter according to some embodiments of the present disclosure.

FIG. 9 is a view illustrating a detailed structure of an adapter according to some other embodiments of the present disclosure.

FIGS. 10 to 12 illustrate various types of aerosol generation devices to which the adapter and technical configurations related thereto according to some embodiments of the present disclosure are applicable.

### [MODES OF THE INVENTION]

Hereinafter, exemplary embodiments of the present disclosure will be described in detail with reference to the accompanying drawings. Advantages and features of the present disclosure and methods of achieving the same should become clear with embodiments described in detail below with reference to the accompanying drawings. However, the technical spirit of the present disclosure is not limited to the following embodiments and may be implemented in various different forms. The embodiments make the technical spirit of the present disclosure complete and are provided to completely inform those of ordinary skill in the art to which the present disclosure pertains of the scope of the present disclosure. The technical spirit of the present disclosure is defined only by the scope of the claims.

In assigning reference numerals to components of each drawing, it should be noted that the same reference numerals are assigned to the same components as much as possible even when the components are illustrated in different drawings. Also, in describing the present disclosure, when detailed description of a known related configuration or function is deemed as having the possibility of obscuring the gist of the present disclosure, the detailed description thereof will be omitted.

Unless otherwise defined, all terms including technical or scientific terms used herein have the same meaning as commonly understood by those of ordinary skill in the art to which the present disclosure pertains. Terms defined in commonly used dictionaries should not be construed in an idealized or overly formal sense unless expressly so defined herein. Terms used herein are for describing the embodiments and are not intended to limit the present disclosure. In the specification, a singular expression includes a plural expression unless the context clearly indicates otherwise.

Also, in describing components of the present disclosure, terms such as first, second, A, B, (a), and (b) may be used. Such terms are only used for distinguishing one component from another component, and the essence, order, sequence, or the like of the corresponding component is not limited by the terms. In a case in which a certain component is described as being “connected,” “coupled,” or “linked” to another component, it should be understood that, although the component may be directly connected or linked to the other component, still another component may also be “connected,” “coupled,” or “linked” between the two components.

The terms “comprises” and/or “comprising” used herein do not preclude the presence or addition of one or more components, steps, operations, and/or devices other than those mentioned.

Prior to the description of various embodiments of the present disclosure, some terms used herein will be clarified.

In the following embodiments, “aerosol-forming substrate” may refer to a material capable of forming an aerosol. The aerosol may include a volatile compound. The aerosol-forming substrate may be solid or liquid.

For example, a solid aerosol-forming substrate may include a solid material (e.g., a medium of a cigarette) based on tobacco raw materials, such as reconstituted tobacco leaves, shredded tobacco, and reconstituted tobacco, and a liquid aerosol-forming substrate may include liquid compositions based on nicotine, tobacco extracts, and/or various flavoring agents. However, the scope of the present disclosure is not limited to the above-listed examples.

As a more specific example, the liquid aerosol-forming substrate may include at least one of propylene glycol (PG) and glycerin (GLY) and may further include at least one of ethylene glycol, dipropylene glycol, diethylene glycol, triethylene glycol, tetraethylene glycol, and oleyl alcohol. As another example, the aerosol-forming substrate may further include at least one of nicotine, moisture, and a flavoring material. As still another example, the aerosol-forming substrate may further include various additives such as cinnamon and capsaicin. The aerosol-forming substrate may not only include a liquid material with high fluidity but also include a material in the form of gel or a solid. In this way, as the components constituting the aerosol-forming substrate, various materials may be selected according to embodiments, and composition ratios thereof may also vary according to embodiments. In the following embodiments, “liquid” may be understood as referring to the liquid aerosol-forming substrate.

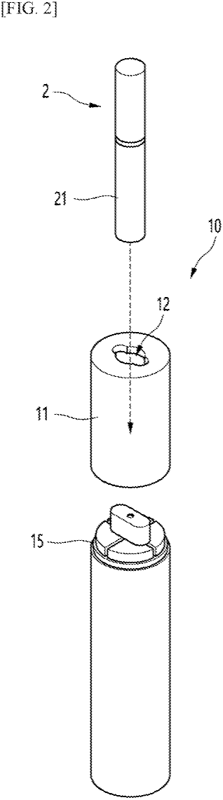

In the following embodiments, “aerosol generation device” may refer to a device that generates an aerosol using an aerosol-forming substrate in order to generate an aerosol that can be inhaled directly into the user’s lungs through the user’s mouth. Examples of the aerosol generation device may include a liquid-type aerosol generation device that uses a liquid to generate an aerosol and a hybrid-type aerosol generation device that uses a liquid and a cigarette together. However, the examples of the aerosol generation device may further include various other kinds of aerosol generation devices, and the scope of the present disclosure is not limited to the above-listed examples. Some examples of the aerosol generation device will be described below with reference to FIG. 2 and FIGS. 10 to 12.

In the following embodiments, “aerosol-generating article” may refer to an article capable of generating an aerosol. The aerosol-generating article may include an aerosol-forming substrate. A typical example of the aerosol-generating article may be a cigarette, but the scope of the present disclosure is not limited to such an example.

In the following embodiments, “puff” refers to inhalation by a user, and the inhalation may refer to a situation in which a user draws smoke into his or her oral cavity, nasal cavity, or lungs through the mouth or nose.

In the following embodiments, “upstream” or “upstream direction” may refer to a direction moving away from an oral region of a smoker, and “downstream” or “downstream direction” may refer to a direction approaching the oral region of the smoker. The terms “upstream” and “downstream” may be used to describe relative positions of components constituting an aerosol-generating article. For example, in an aerosol-generating article 2 illustrated in FIG. 2 and so on, a medium portion 21 is disposed upstream or in an upstream direction of other portions.

In the following embodiments, “longitudinal direction” or “longitudinal axis” may refer to a direction that corresponds to the longitudinal axis of an aerosol-generating article.

Hereinafter, various embodiments of the present disclosure will be described in detail with reference to the accompanying drawings.

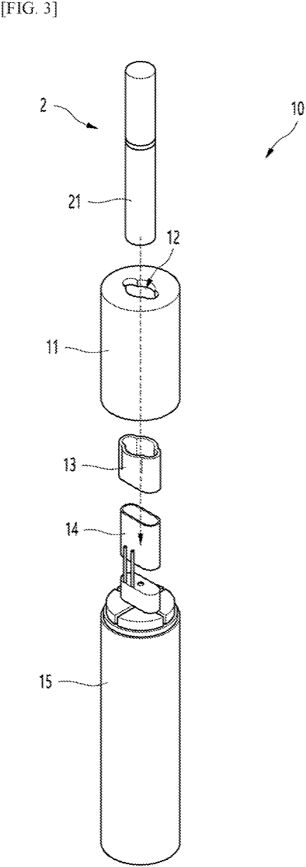

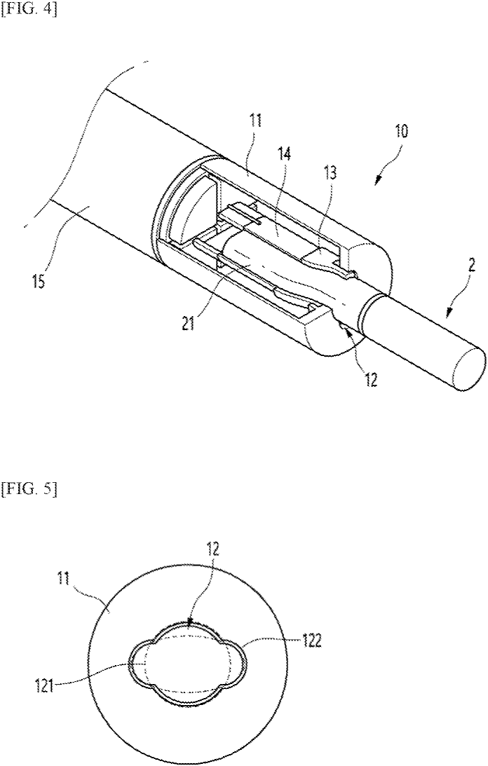

FIG. 2 is an exemplary view schematically illustrating an aerosol generation device 10 according to some embodiments of the present disclosure, and FIG. 3 is an exemplary exploded view schematically illustrating the aerosol generation device 10. Also, FIG. 4 schematically illustrates an internal structure of the aerosol generation device 10 in a state in which the aerosol-generating article 2 is inserted into the aerosol generation device 10. In particular, FIGS. 3 and 4 mainly illustrate components inside an upper case 11. Hereinafter, description will be given with reference to FIGS. 2 to 4.

As illustrated in FIG. 2 and so on, the aerosol generation device 10 may be a device that uses the aerosol-generating article 2 to generate an aerosol. More specifically, the aerosol generation device 10 may electrically heat the aerosol-generating article 2, which is inserted into the aerosol generation device 10, to generate an aerosol. The generated aerosol may be inhaled by the user through the oral region of the user.

The aerosol-generating article 2 may include the medium portion 21 which may include an aerosol-forming substrate. The medium portion 21 may be disposed at an upstream portion of the aerosol-generating article 2. The medium portion 21 may be inserted into an insertion hole 12 of the aerosol generation device 10 and may generate an aerosol when heated by a heater 14 which is disposed inside the aerosol generation device 10. Here, at least a portion of the medium portion 21 may be deformed to a desired pressed shape by an adapter 13. Through the deformation, a distance from the heater 14 to the central portion of the medium portion 21 may be decreased, and the heating efficiency of the heater 14 may be improved. Further, power consumption of the aerosol generation device 10 may be reduced, a preheating time may be reduced, and a tobacco smoke taste of the aerosol-generating article 2 may be enhanced. The adapter 13 and technical configurations related thereto will be described in detail below.

The desired pressed shape is a shape in a state in which an original shape of the medium portion 21 is pressed, and examples of the desired pressed shape may include various shapes that can improve heating efficiency of the heater 14, such as an elliptical shape or an ellipse-like shape (e.g., an elongated elliptical shape). However, the desired pressed shape is not limited thereto. Hereinafter, for convenience of understanding, description will be continued assuming that the original shape of the medium portion 21 (or the aerosol-generating article 2) is a cylindrical shape and the desired pressed shape is an elongated elliptical shape.

As illustrated in FIG. 2 and so on, the aerosol generation device 10 may include the upper case 11, the adapter 13, the heater 14, and a control main body 15. However, only the components relating to the embodiment of the present disclosure are illustrated in FIG. 2 and so on. Therefore, those of ordinary skill in the art to which the present disclosure pertains should understand that the aerosol generation device 10 may further include general-purpose components other than the components illustrated in FIG. 2 and so on. For example, the aerosol generation device 10 may further include an output device (e.g., a motor, a display, or a speaker) configured to output various pieces of information such as a state of the device and/or an input device (e.g., a button) configured to receive an input on various pieces of information (e.g., the on/off of the device) from a user. Hereinafter, each component of the aerosol generation device 10 will be described.

The upper case 11 may form an exterior of an upper portion of the aerosol generation device 10. The upper case 11 may be designed to have a suitable form in consideration of the functionality, aesthetics, or the like of the aerosol generation device 10. Therefore, the form of the upper case 11 is not limited to that illustrated in FIG. 2. For example, although the drawings such as FIG. 2 illustrate the upper case 11 as being separated from a case of the control main body 15, the upper case 11 and the case of the control main body 15 may also be integrally formed. The upper case 11 may be made of a material suitable for protecting components inside the aerosol generation device 10.

The insertion hole 12 may be formed in the upper case 11, and the aerosol-generating article 2 may be inserted into the aerosol generation device 10 through the insertion hole 12. For example, as illustrated, the insertion hole 12 may be formed at an end of the upper case 11.

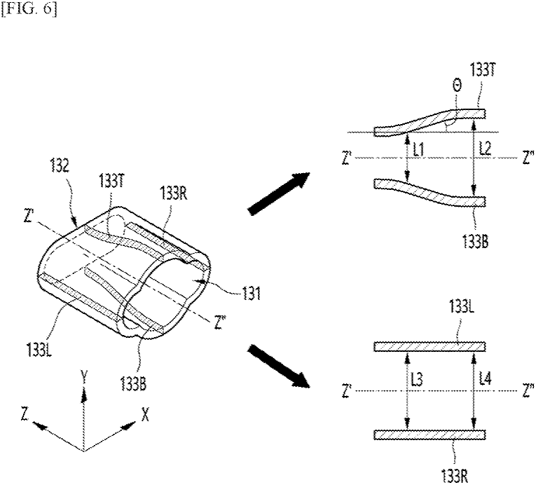

Preferably, the insertion hole 12 may be designed to have a shape that allows easy insertion of the aerosol-generating article 2 and allows easy removal of the aerosol-generating article 2 even when the aerosol-generating article 2 is deformed due to the adapter 13. Therefore, in some embodiments of the present disclosure, the insertion hole 12 may be designed to have a shape (that is, a composite shape) in which a cross-section of the aerosol-generating article 2 (that is, a cross-section thereof before deformation) and a cross-section of the desired pressed shape are combined. For example, assume that the cross-section of the aerosol-generating article 2 has a circular shape while the cross-section of the desired pressed shape has an elongated elliptical shape. In this case, as illustrated in FIG. 5, a cross-section of the insertion hole 12 may have a shape in which a circular shape 121 and an elongated elliptical shape 122 are combined. In this way, the aerosol-generating article 2 may be easily inserted through the circular portion 121 of the insertion hole 12, and the aerosol-generating article 2, which is deformed to the elongated elliptical shape, may be easily removed through the elliptical portion 122 of the insertion hole 12. For example, since the medium portion 21 solidifies as smoking progresses, the medium portion 21 may be easily damaged when caught in the insertion hole 12. Also, a wrapper of the aerosol-generating article 2 may be broken when caught in the insertion hole 12. However, such problems may be prevented in the case in which the cross-section of the insertion hole 12 has the shape illustrated in FIG. 5.

Description will be given by referring back to FIGS. 2 to 4.

The adapter 13 may be disposed between the insertion hole 12 and the heater 14 to allow at least a portion of the medium portion 21 to be deformed to the desired pressed shape. That is, the adapter 13 may perform a function of adapting the shape of the medium portion 21 to the desired pressed shape. Refer to FIG. 4 for an example in which the aerosol-generating article 2 is inserted into the aerosol generation device 10 through the insertion hole 12 and the adapter 13.

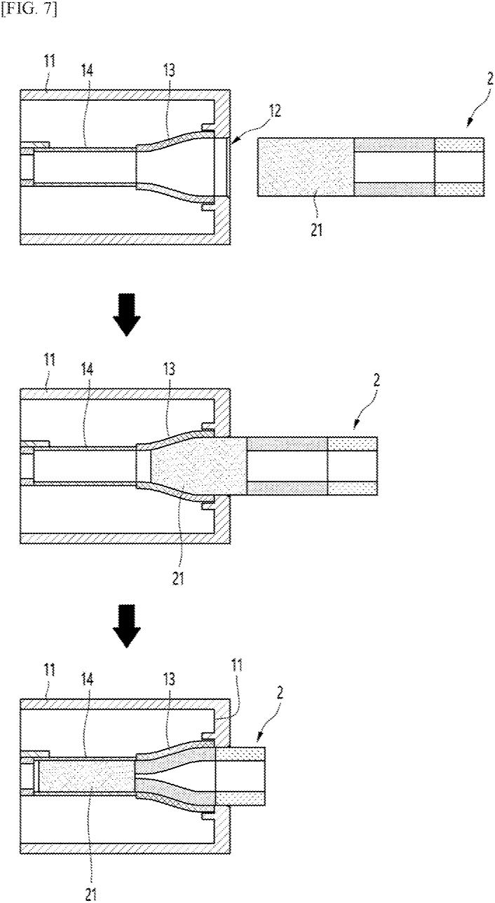

Here, at least a portion of the medium portion 21 being deformed to the desired pressed shape may mean that a portion of the aerosol-generating article 2 including the medium portion 21 or at least a portion of the medium portion 21 is deformed to the desired pressed shape. The detailed structure and operation principle of the adapter 13 will be described in detail below with reference to FIG. 6 and so on.

Next, the heater 14 may heat the aerosol-generating article 2, which is deformed due to the adapter 13, to generate an aerosol. More specifically, the heater 14 may heat the medium portion 21, which is deformed to the desired pressed shape due to the adapter 13, to generate an aerosol. A heating temperature of the heater 14 may be controlled by the control main body 15.

As illustrated in FIGS. 3 and 4, preferably, the heater 14 may be designed to externally heat the deformed medium portion 21. However, the scope of the present disclosure is not limited thereto, and the heater 14 may also be designed as an internal-heating type.

In some embodiments, at least a portion of the heater 14 (or at least a portion of a heating space formed by the heater 14) may have a shape that matches the shape of the deformed medium portion 21 (e.g., the desired pressed shape or a shape similar thereto). For example, in a case in which the desired pressed shape is an elongated elliptical shape, the heater 14 (or the heating space formed by the heater 14) may also have an elongated elliptical shape. In this way, the heater 14 and the medium portion 21 may be able to come in close contact with each other, or a distance from the heater 14 to the central portion of the medium portion 21 may be minimized, and thus the heating efficiency of the heater 14 may be further improved. Meanwhile, although the drawings such as FIG. 3 illustrate an example in which the heater 14 is formed as one body, the heater 14 may have a structure that consists of more than one component. For example, the heater 14 may include a first heater and a second heater that heat both sides of the medium portion 21 which is deformed to the desired pressed shape, and a combined shape of the first heater and the second heater may be an elongated elliptical shape.

In some embodiments, the heater 14 may be an external-heating type, and at least a portion of the heater 14 may have an inclined structure (shape). Also, the medium portion 21 may be firstly deformed due to the adapter 13 and secondarily deformed due to the inclined structure. For example, the medium portion 21 may be deformed to a pressed shape (e.g., deformed to a first elongated elliptical shape) while passing through the adapter 13 and then deformed to a further pressed shape (e.g., deformed to a second elongated elliptical shape which is pressed more than the first elongated elliptical shape) due to the inclined structure while being accommodated in the heating space of the heater 14. In this case, since the deformation of the medium portion 21 is slowly performed through the adapter 13 and the heater 14, the risk of damage to the medium portion 21 or the wrapper during the deformation may be significantly reduced. Otherwise, in order for the medium portion 21 to be immediately deformed to the desired pressed shape due to the adapter 13, an internal structure of the adapter 13 has to have a steep slope, and accordingly, the medium portion 21 or the wrapper may be damaged during the deformation. However, in the present embodiment, the internal structure of the adapter 13 may be designed to have a gentle slope, and thus the stability of the deformation process may be significantly improved. Further, since the desired pressed shape may be set to a further pressed shape, the heating efficiency of the heater 14 may be further improved in some cases.

Also, in some embodiments, at least a portion of the heater 14 may be made of a shape-changing material whose shape changes due to heat. Also, the heater 14 may be deformed during heating and press the medium portion 21 accommodated therein. In this case, since the heater 14 and the medium portion 21 may come in closer contact such that the medium portion 21 is further pressed by the heater 14, the heating efficiency of the heater 14 may be further improved. Meanwhile, in a case in which the operation of the heater 14 stops (or ends) due to reasons such as the end of smoking, a portion of the heater 14 that has been deformed may be restored to its original shape and the pressing (or close contact) may be released. Accordingly, the aerosol-generating article 2 may be easily removed.

In the previous embodiments, a cooling element may be disposed around the heater 14. The cooling element may operate to cool the heater 14 after use of the aerosol generation device 10 has ended (e.g., the end of smoking). The operation of the cooling element may be controlled by the control main body 15. In this case, since the heater 14 may be rapidly restored to its original shape, the pressing on the medium portion 21 may be rapidly released. Accordingly, after the use of the aerosol generation device 10 has ended, the aerosol-generating article 2 may be promptly removed without damage. Otherwise, in a case in which the heater 14 is not rapidly restored to its original shape and the aerosol-generating article 2 is removed before the pressing is released, the wrapper of the aerosol-generating article 2 or a residual portion of the medium portion 21 may be damaged, and thus the inside of the aerosol generation device 10 may be contaminated. However, such problems may be significantly alleviated when the cooling element is disposed.

The heater 14 may be an electrically resistive heater or may operate by an induction heating method. In this way, the type or heating method of the heater 14 may be designed in various ways, and the scope of the present disclosure is not limited by the type or heating method of the heater 14.

Next, the control main body 15 may control the overall operation of the aerosol generation device 10. More specifically, the control main body 15 may be configured to include a lower case, a battery (not illustrated), and a controller (not illustrated), and the controller (not illustrated) may control the overall operation of the aerosol generation device 10. Hereinafter, each component of the control main body 15 will be briefly described.

The lower case may form an exterior of the control main body 15 (an exterior of a lower portion of the aerosol generation device 10). Like the upper case 11, the lower case is designed to have a suitable form in consideration of the functionality, aesthetics, or the like of the aerosol generation device 10. Therefore, the form of the lower case is not limited to that illustrated in FIG. 2. The lower case may be made of a material suitable for protecting the battery (not illustrated) and the controller (not illustrated).

Next, the battery (not illustrated) may supply power used to operate the aerosol generation device 10. For example, the battery (not illustrated) may supply power to allow the heater 14 to operate and may supply power required for operation of the controller (not illustrated).

Next, the controller (not illustrated) may control the overall operation of the aerosol generation device 10. For example, the controller (not illustrated) may control the operation of the heater 14 and the battery (not illustrated) and may also control the operation of other components included in the aerosol generation device 10. The controller (not illustrated) may control the power supplied by the battery (not illustrated), the heating temperature of the heater 14, and the like.

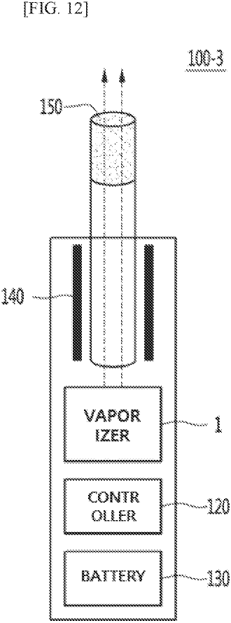

Refer to the description of FIGS. 10 to 12 for further details of the battery (not illustrated) and the controller (not illustrated).

The aerosol generation device 10 according to some embodiments of the present disclosure has been described above with reference to FIGS. 2 to 5. According to the above description, when the aerosol-generating article 2 is inserted, the medium portion 21 may be naturally deformed to the desired pressed shape due to the internal structure (shape) of the adapter 13 and an insertion force of the aerosol-generating article 2. Accordingly, the distance from the heater 14 to the central portion of the medium portion 21 may be decreased, and the heating efficiency of the heater 14 may be improved. For example, temperature differences between portions of the medium portion 21 may be minimized, and an aerosol-forming substrate inside the medium portion 21 may rapidly reach a target temperature. Also, due to the improvement in heating efficiency, a preheating time of the aerosol generation device 10 may be reduced, power consumption may be reduced, and a tobacco smoke taste of the aerosol-generating article 2 may be enhanced. Also, since the heater 14 has a shape that matches the desired pressed shape, the heating efficiency of the heater 14 may be further improved. Also, since the cross-section of the insertion hole 12 has a shape in which the cross-section of the aerosol-generating article 2 and the cross-section of the desired pressed shape are combined, both insertion and removal of the aerosol-generating article 2 may be easily performed.

Hereinafter, the detailed structure and operation principle of the adapter 13 according to some embodiments of the present disclosure will be described with reference to FIG. 6 and so on.

FIG. 6 is an exemplary view illustrating the adapter 13 according to some embodiments of the present disclosure. In particular, FIG. 6 illustrates the shape of the adapter 13 in a case in which the desired pressed shape is an elongated elliptical shape. However, the shape of the adapter 13 may be changed according to the desired pressed shape. In the following description, for convenience of understanding, description will be given assuming that the X-axis corresponds to a horizontal direction of a cross-section of the adapter 13, the Y-axis corresponds to a vertical direction of the cross-section of the adapter 13, and the Z-axis corresponds to a depth direction of the adapter 13 (or a direction in which the aerosol-generating article 2 is inserted).

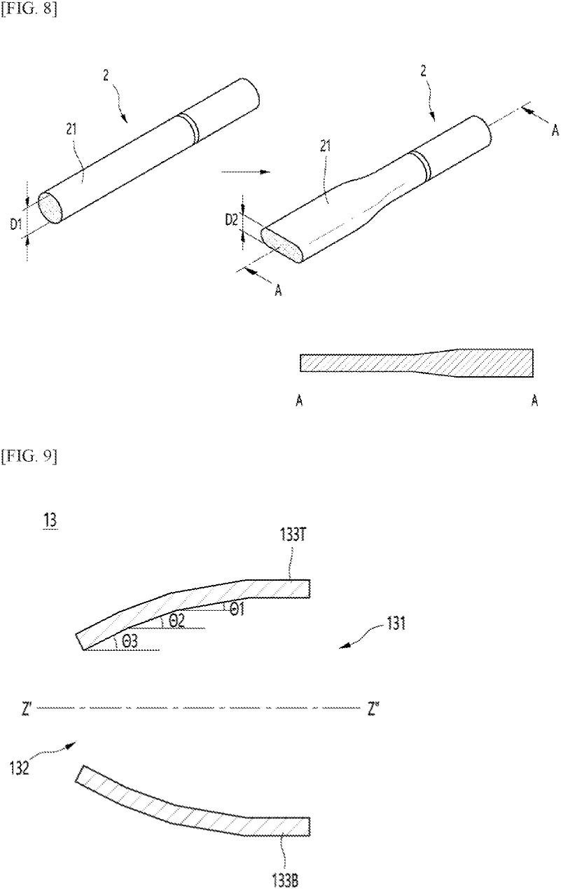

As illustrated in FIG. 6, the adapter 13 may have a structure in which a space is formed and both end portions 131 and 132 are open. Here, a first open end portion 131 disposed on the insertion hole 12 side may serve as an inlet for the medium portion 21, a second open end portion 132 disposed on the heater 14 side may serve as an outlet, and at least a portion of the inner space may have an inclined structure (shape). The medium portion 21 entering through the first open end portion 131 of the adapter 13 and moving toward the second open end portion 132 along the inner space of the adapter 13 may be deformed to the desired pressed shape due to the internal structure (shape). For example, as illustrated in FIG. 7, the medium portion 21 having a cylindrical shape may be naturally deformed to an elongated elliptical shape due to the internal structure (shape) of the adapter 13 and the insertion force of the aerosol-generating article 2.

As illustrated, like the insertion hole 12, a cross-section of the first open end portion 131 may be designed to have a shape in which the cross-section of the medium portion 21 and the cross-section of the desired pressed shape are combined. For example, the cross-section of the first open end portion 131 may have a shape in which a cylindrical shape and an elongated elliptical shape are combined. In this way, the aerosol-generating article 2 may be easily inserted and removed without damage thereto.

Although not clearly illustrated, a cross-section of the second open end portion 132 may be designed to match the cross-section of the desired pressed shape. For example, the cross-section of the second open end portion 132 may have an elongated elliptical shape. In this way, the medium portion 21 may be appropriately deformed to the desired pressed shape.

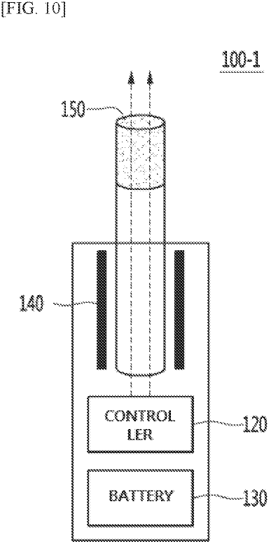

As illustrated in FIG. 6, the inner space of the adapter 13 may be designed to have a cross-sectional area that tends to decrease from the first open end portion 131 toward the second open end portion 132. Here, a length of a cross-section of the inner space in the Y-axis direction (a vertical length of the cross-section; e.g., distances L1 and L2 between a top surface 133T and a bottom surface 133B of the adapter) may tend to decrease from the first open end portion 131 toward the second open end portion 132 (e.g., L1 < L2), and a length of the cross-section of the inner space in the X-axis direction (a horizontal length of the cross-section; distances L3 and L4 between a left surface 133L and a right surface 133R of the adapter) may be constant from the first open end portion 131 to the second open end portion 132 (e.g., L3 = L4). In this case, as illustrated in FIG. 8, the medium portion 21 may be stably deformed to an elongated elliptical shape by being pushed in the horizontal direction when pressed in the vertical direction.

Description will be given by referring back to FIG. 6.

Meanwhile, an angle of inclination θ of the adapter 13 and an extent to which the medium portion 21 is pressed to have the desired pressed shape may be appropriately designed in consideration of the heating efficiency of the heater 14 and the risk of damage to the medium portion 21 and the wrapper and may vary according to an embodiment. Here, the angle of inclination θ may refer to an angle of an inclined surface inside the adapter 13 with respect to a longitudinal axis (that is, the Z-axis) of the aerosol-generating article 2 (see FIG. 6).

In some embodiments, the angle of inclination θ may be in a range of about 5° to 60°, preferably in a range of about 10° to 50° or about 10° to 40°. More preferably, the angle of inclination θ may be in a range of about 15° to 35°, about 20° to 40°, or about 15° to 35°. It was confirmed that, within such numerical ranges, the medium portion 21 is appropriately deformed to the pressed shape and the risk of damage during deformation is significantly reduced. For example, in a case in which the angle of inclination is too small, the extent to which the medium portion 21 is pressed is low, and thus an effect of improving the heating efficiency of the heater 14 and an effect of reducing the preheating time may be reduced. Conversely, in a case in which the angle of inclination is too large, a problem may occur in which the medium portion 21 or wrapper is damaged due to rapid deformation.

For reference, for smooth insertion of the medium portion 21, the inclined surface (or inclined structure) inside the adapter 13 may be formed as a curved surface, and in this case, the angle of inclination θ may refer to an average angle formed between the longitudinal axis of the aerosol-generating article 2 and a tangent line of the curved surface.

Also, in some embodiments, a thickness (e.g., D2 in FIG. 8) of the deformed medium portion 21 may be in a range of about 10% to 90%, preferably, in a range of about 20% to 80%, about 30% to 90%, or about 10% to 70%, and more preferably, in a range of about 20% to 60%, about 30% to 60%, or about 30% to 70%, of a thickness (e.g., D1 of FIG. 8) of the medium portion 21 before deformation. It was confirmed that, within such numerical ranges, the heating efficiency of the heater 14 is guaranteed and the risk of damage to the medium portion 21 or wrapper is significantly reduced.

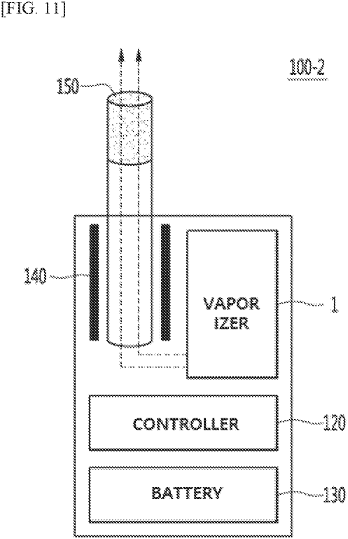

Also, in some embodiments, the adapter 13 may be designed to have an angle of inclination that tends to increase from the first open end portion 131 toward the second open end portion 132. For example, the adapter 13 may have an inclined structure illustrated in FIG. 9, a second angle of inclination θ2 may be larger than a first angle of inclination θ1, and a third angle of inclination θ3 may have a larger value than the second angle of inclination θ2. In this case, during insertion of the aerosol-generating article 2, a feeling of the medium portion 21 being slightly caught in the adapter 13 may be repeatedly conveyed to the user, and an effect of indirectly limiting an insertion speed of the aerosol-generating article 2 may be achieved, thus reducing the risk of damage to the medium portion 21 or wrapper.

Meanwhile, preferably, the adapter 13 may be made of a material with a low surface roughness or a material with a low frictional coefficient. For example, the adapter 13 may be made of a metal material such as stainless steel. In this case, the aerosol-generating article 2 may smoothly pass through the adapter 13, and the risk of damage during deformation may be reduced.

In some embodiments, treatment to reduce a surface roughness may be performed on an inner surface of the adapter 13. Such surface treatment may include various coating processes that smoothen a surface but is not limited thereto. According to the present embodiment, as the surface roughness of the inner surface of the adapter 13 decreases, the medium portion 21 may be smoothly inserted, and thus an insertion force required for deformation may be minimized. Also, as the medium portion 21 is smoothly inserted, the risk of damage during deformation may be further reduced.

The detailed structure and operation principle of the adapter 13 according to some embodiments of the present disclosure have been described in detail above with reference to FIGS. 6 to 9. According to the above description, the medium portion 21 may be naturally deformed to the desired pressed shape through the internal structure of the adapter 13 and the insertion force of the aerosol-generating article 2, and accordingly, the heating efficiency of the heater 14 may be improved. Also, since the adapter 13 does not require a user’s intervention for deformation except for inserting the aerosol-generating article 2, user convenience may be improved as compared to the related art in which deformation is performed using a pressing force exerted by a user.

Hereinafter, various types of aerosol generation devices 100-1 to 100-3 to which the adapter 13 and technical configurations related thereto (e.g., the insertion hole 12, the heater 14, and the like) according to some embodiments of the present disclosure are applicable will be introduced.

FIGS. 10 to 12 are exemplary block diagrams illustrating the aerosol generation devices 100-1 to 100-3. Specifically, FIG. 10 illustrates a cigarette-type aerosol generation device 100-1, and FIGS. 11 and 12 illustrate hybrid-type aerosol generation devices 100-2 and 100-3 that use a liquid and a cigarette together. Hereinafter, each of the aerosol generation devices 100-1 to 100-3 will be described.

As illustrated in FIG. 10, the aerosol generation device 100-1 may include a heater 140, a battery 130, and a controller 120. However, this is only a preferred embodiment for achieving the objectives of the present disclosure, and, of course, some components may be added or omitted as necessary. Also, the components of the aerosol generation device 100-1 illustrated in FIG. 10 represent functional components that are functionally distinct, and the plurality of components may be implemented in a form of being integrated with each other in an actual physical environment, or a single component may be implemented in a form of being divided into a plurality of specific functional components. Hereinafter, each component of the aerosol generation device 100-1 will be described.

The heater 140 may be disposed around a cigarette 150 to heat the cigarette 150. The cigarette 150 may include a solid aerosol-forming substrate and generate an aerosol when heated. The generated aerosol may be inhaled by a user through the oral region of the user. The heater 140 may correspond to the above-described heater 14, and a heating temperature of the heater 140 may be controlled by the controller 120.

Next, the battery 130 may supply power used to operate the aerosol generation device 100-1. For example, the battery 130 may supply power to allow the heater 140 to heat the aerosol-forming substrate included in the cigarette 150 and may supply power required for the operation of the controller 120.

Also, the battery 130 may supply power required to operate electrical components such as a display (not illustrated), a sensor (not illustrated), and a motor (not illustrated) which are installed in the aerosol generation device 100-1.

Next, the controller 120 may control the overall operation of the aerosol generation device 100-1. For example, the controller 120 may control the operation of the heater 140 and the battery 130 and may also control the operation of other components included in the aerosol generation device 100-1. The controller 120 may control the power supplied by the battery 130, the heating temperature of the heater 140, and the like. Also, the controller 120 may check a state of each of the components of the aerosol generation device 100-1 and determine whether the aerosol generation device 100-1 is in an operable state.

The controller 120 may be implemented with at least one processor. The processor may also be implemented with an array of a plurality of logic gates or implemented with a combination of a general-purpose microprocessor and a memory which stores a program that may be executed by the microprocessor. Also, those of ordinary skill in the art to which the present disclosure pertains should clearly understand that the controller 120 may also be implemented with other forms of hardware.

Hereinafter, the hybrid-type aerosol generation devices 100-2 and 100-3 will be briefly described with reference to FIGS. 11 and 12.

FIG. 11 illustrates the aerosol generation device 100-2 in which a vaporizer 1 and the cigarette 150 are disposed in parallel, and FIG. 12 illustrates the aerosol generation device 100-3 in which the vaporizer 1 and the cigarette 150 are disposed in series. However, an internal structure of an aerosol generation device is not limited to those illustrated in FIGS. 11 and 12, and the arrangement of components may be changed according to a design method.

In FIGS. 11 and 12, the vaporizer 1 may vaporize a liquid aerosol-forming substrate to generate an aerosol. The aerosol generated by the vaporizer 1 may pass through the cigarette 150 and be inhaled by a user through the oral region of the user.

A detailed structure of the vaporizer 1 may be designed in various ways, and the vaporizer 1 according to some embodiments may include a liquid reservoir configured to store a liquid aerosol-forming substrate, a wick configured to absorb the aerosol-forming substrate, and a vaporizing element configured to vaporize the absorbed aerosol-forming substrate. The vaporizing element may be implemented as a heating element that vaporizes a liquid through heating. However, the vaporizing element is not limited thereto and may also vaporize a liquid through ultrasonic vibrations or the like. The operation of the vaporizing element may be controlled by the controller 120.

Various types of aerosol generation devices 100-1 to 100-3, to which the adapter 13 and technical configurations related thereto according to some embodiments of the present disclosure are applicable, have been described above with reference to FIGS. 10 to 12.

All the components constituting the embodiments of the present disclosure have been described above as being combined into one body or being operated in combination, but the technical spirit of the present disclosure is not necessarily limited to the embodiments. That is, any one or more of the components may be selectively operated in combination within the intended scope of the present disclosure.

The embodiments of the present disclosure have been described above with reference to the accompanying drawings, but those of ordinary skill in the art to which the present disclosure pertains should understand that the present disclosure may be carried out in other specific forms without changing the technical spirit or essential features thereof. Therefore, the embodiments described above should be understood as being illustrative, instead of limiting, in all aspects. The scope of the present disclosure should be interpreted by the claims below, and any technical spirit within the scope equivalent to the claims should be interpreted as falling within the scope of the technical spirit defined by the present disclosure.

What is claimed is:

1. An aerosol generation device comprising:
a case including an insertion hole for receiving an aerosol-generating article;
a heater configured to generate an aerosol by heating the aerosol-generating article inserted in the insertion hole; and
an adapter disposed between the insertion hole and the heater and configured to deform a medium portion of the inserted aerosol-generating article to a desired pressed shape.

2. The aerosol generation device of claim 1, wherein a cross-section of the insertion hole has a shape in which a cross-section of the aerosol-generating article and a cross-section of the desired pressed shape are combined.

3. The aerosol generation device of claim 1, wherein:
the adapter includes a first open end portion disposed on an insertion hole side and a second open end portion disposed on an heater side; and
while the inserted aerosol-generating article is moved toward the second open end portion through the first open end portion, the medium portion is deformed to the desired pressed shape due to an inner shape of the adapter.

4. The aerosol generation device of claim 3, wherein a cross-section of the first open end portion has a shape in which a cross-section of the aerosol-generating article and a cross-section of the desired pressed shape are combined.

5. The aerosol generation device of claim 3, wherein a cross-section of the second open end portion matches a cross-section of the desired pressed shape.

6. The aerosol generation device of claim 3, wherein a cross-sectional area of an inner space of the adapter tends to decrease from the first open end portion toward the second open end portion.

7. The aerosol generation device of claim 6, wherein:
a length of a cross-section of the inner space in an X-axis direction is constant; and
a length of the cross-section of the inner space in a Y-axis direction tends to decrease from the first open end portion toward the second open end portion.

8. The aerosol generation device of claim 3, wherein:
at least a portion of an inner space of the adapter has an inclined structure; and
an angle of inclination of the at least one portion with respect to a longitudinal axis of the aerosol-generating article is in a range of 10° to 40°.

9. The aerosol generation device of claim 3, wherein:
at least a portion of an inner space of the adapter has an inclined structure; and
an angle of inclination of the at least one portion with respect to a longitudinal axis of the aerosol-generating article tends to increase from the first open end portion toward the second open end portion.

10. The aerosol generation device of claim 1, wherein treatment to reduce a surface roughness is performed on at least a portion of an inner surface of the adapter.

11. The aerosol generation device of claim 1, wherein:
the heater is an external-heating type; and
at least a portion of the heater has a shape that matches the desired pressed shape.

12. The aerosol generation device of claim 1, wherein:
the heater is an external-heating type;
at least a portion of the heater has an inclined structure such that the medium portion inserted through the adapter is deformed to a further pressed shape due to the inclined structure while being accommodated in a heating space of the heater.

13. The aerosol generation device of claim 1, wherein a thickness of the medium portion deformed to the desired pressed shape is in a range of 20% to 80% of a thickness of the medium portion before deformation.
